(19) United States
(12) Patent Application Publication
(10) Pub. No.: US 2010/0004897 A1
(43) Pub. Date: Jan. 7, 2010

(54) Method and Device for Recognizing Jamming of a Seat

(75) Inventors: Bernhard Pfeffer, Bischofsmais (DE); Gerald Schicker, Maxhutte-Haidhof (DE)

Correspondence Address: LERNER GREENBERG STEMER LLP, P O BOX 2480, HOLLYWOOD, FL, 33022-2480, US

(73) Assignee: CONTINENTAL AUTOMOTIVE GMBH, Hannover (DE)

(21) Appl. No.: 12/304,014

(22) PCT Filed: Apr. 20, 2007
(86) PCT No.: PCT/EP2007/053899

§ 371 Date: Jan. 22, 2009

(30) Foreign Application Priority Data
Jun. 9, 2006 (DE) 102006026926.8

(51) Int. Cl. G06F 15/00; G01G 9/00

(52) U.S. Cl. 702/173

(57) ABSTRACT

At least two weight sensors are disposed below the seat such that measured values of the at least two weight sensors are representative of a force which is transmitted from the seat to its mount. At least two measured values are detected at a chronological interval from each other within a predetermined period of time by the weight sensors. A weight sensor is arranged in a first region of the seat and a weight sensor is arranged in a second region of the seat. A gradient is determined from the respective at least two measured values for the particular weight sensor. The jamming of the seat is recognized in dependence on the presence of different gradient signs that are assigned to the weight sensor disposed in the first region of the seat and to the weight sensor disposed in the second region of the seat.

The invention relates to a method and a corresponding device for recognizing jamming of a seat, in particular a seat in a motor vehicle.

Depending on a seat occupancy of a seat in a motor vehicle, retaining systems such as seatbelts or airbags which are assigned to the relevant seat should be suitably adapted in the event of an accident in order to prevent injuries to vehicle occupants. For this purpose, the seat occupancy is classified into different classes, e.g. “the seat is free” or “someone is sitting on the seat”.

The invention addresses the problem of providing a method and a corresponding device, which are simple and reliable, for recognizing jamming of a seat.

This problem is solved by the features in the independent claims. Advantageous developments of the invention are characterized in the subclaims.

The invention is characterized by a method and a corresponding device for recognizing jamming of a seat. At least two weight sensors are arranged below the seat, such that measured values from the at least two weight sensors are representative of a force which is transferred from the seat to its mounting. Within a predetermined time period, at least two measured values which are separated by a time interval are captured by each of the at least two weight sensors. At least one weight sensor is arranged in a first region of the seat and at least one weight sensor is arranged in a second region of the seat.

An increase is calculated from the at least two measured values for the relevant weight sensor. The jamming of the seat is recognized as a function of the presence of different operational signs of the increases which are attributed to the at least one weight sensor arranged in the first region of the seat and to the at least one weight sensor arranged in the second region of the seat.

The invention is based on the insight that a characteristic profile of the measured values is produced when the seat is jammed. With reference to the different operational signs of the increases, it is very easy to recognize a transition from an unjammed state to a jammed state of the seat. As a result, the jamming of the seat can be recognized very easily and reliably. Furthermore, it is thereby possible, in addition to heavy jammings of the seat, also reliably to recognize light and medium-weight jammings of the seat. If the weight sensors are part of a weight-based occupant recognition in a motor vehicle, then the occupant can be warned if the jamming of the seat is recognized, such that said occupant can remedy the jamming of the seat. As a result of this, it is possible to avoid an incorrect classification of the occupant sitting on the seat. The occupant recognition can therefore take place more reliably and the safety of the occupant in the motor vehicle can be increased.

The first region and the second region of the seat are respectively e.g. a front and rear region of the seat, or a right-hand region and a left-hand region of the seat. The weight sensors are arranged e.g. between an underside of the seat and a mounting which is respectively assigned to the seat.

In an advantageous embodiment, the jamming of the seat is recognized if the increases, which are attributed to the at least one weight sensor arranged in the first region of the seat and the at least one weight sensor arranged in the second region of the seat, exceed a predetermined increase threshold value in terms of their amount in each case. The advantage is that the jamming of the seat can be detected very easily in this way.

In a further advantageous embodiment, the jamming of the seat is recognized if, within the predetermined time period and as a function of the presence of the different operational signs of the increases, an amount of a difference between the measured values of the at least one weight sensor arranged in the first region of the seat and the at least one weight sensor arranged in the second region of the seat exceeds a predetermined difference threshold value. This has the advantage that the recognition of the jamming of the seat is simple and particularly reliable.

In a further advantageous embodiment, a current center of force is calculated from the measured values of the weight sensors. The jamming of the seat is recognized if, within the predetermined time period and as a function of the presence of the different operational signs of the increases, a position of the current center of force lies outside of a predetermined central region. This has the advantage that the recognition of the jamming of the seat is simple and particularly reliable.

Exemplary embodiments of the invention are explained in greater detail below with reference to the schematic drawings, in which:

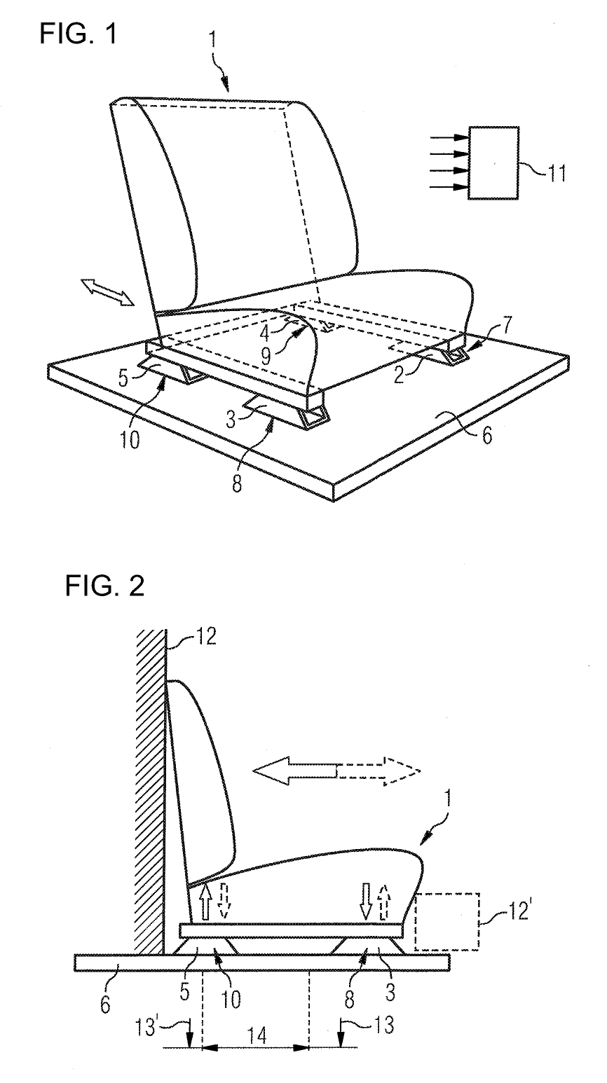

FIG. 1 shows a seat,

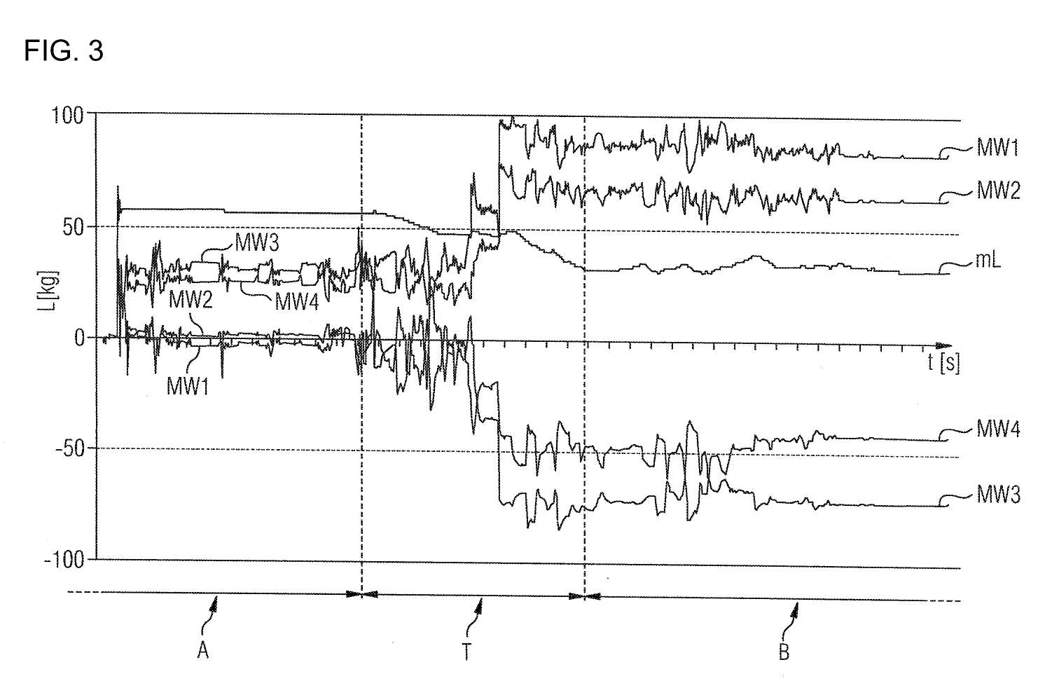

FIG. 2 shows a jammed seat,

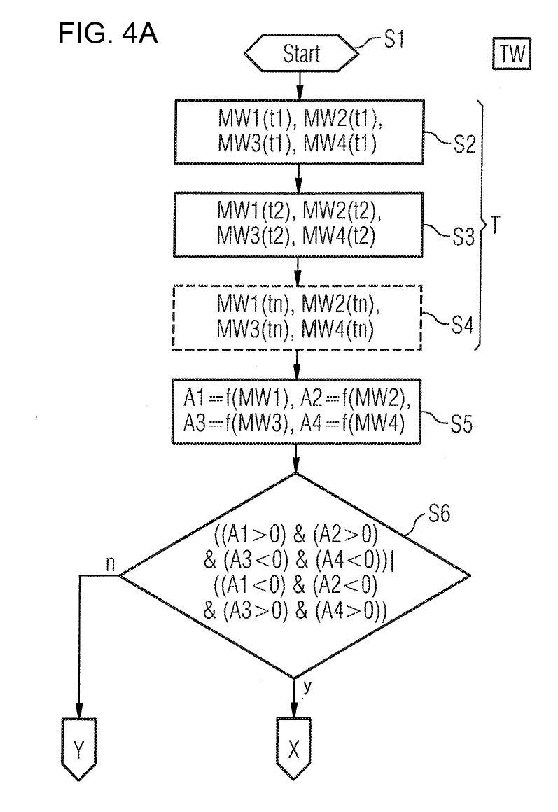

FIG. 3 shows a load/time diagram,

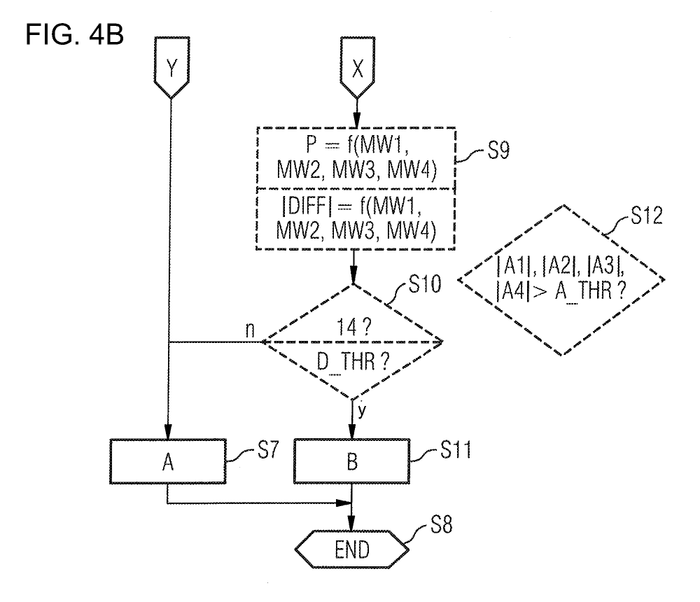

FIGS. 4A and 4B show flow diagrams.

Elements having identical structure or function are assigned the same reference characters in all the figures.

A seat 1, e.g. a seat in a motor vehicle, is mounted on a first mounting 2, a second mounting 3, a third mounting 4 and a fourth mounting 5 (FIG. 1). The mountings are attached to a floor element 6. The four mountings are arranged at a corner of the seat 1 in each case. Furthermore, the mountings are designed as rails, in which the seat 1 can be pushed forwards or backwards. The first mounting 2 and the second mounting 3 are arranged in a front region of the seat 1 and the third mounting 4 and the fourth mounting 5 are arranged in a rear region of the seat. Furthermore, the first mounting 2 and the third mounting 4 are arranged in a left-hand region of the seat and the second mounting 3 and the fourth mounting 5 are arranged in a right-hand region of the seat 1.

A weight sensor is arranged in each case between an underside of the seat 1 and the relevant mounting. A first weight sensor 7 is assigned to the first mounting 2, a second weight sensor 8 is assigned to the second mounting 3, a third weight sensor 9 is assigned to the third mounting 4, and a fourth weight sensor 10 is assigned to the fourth mounting 5. The weight sensors are designed to capture measured values which are representative of a force which is transferred from the seat 1 to the relevant mounting. The weight sensors are preferably designed such that they can capture both compressive forces and tensile forces. For example, compressive forces result in positive measured values and tensile forces result in negative measured values. The measurement region can also be designed differently, however. The weight sensors are coupled to an analysis device 11 and make the relevant measured values available to the analysis device 11. The analysis device 11 is designed to analyze the measured values and recognize a jamming of the seat 1.

The jamming of the seat 1 occurs e.g. if the seat is pushed against and/or onto an object 12, 12′. Such an object 12 is e.g. a wall, against which the seat 1 is moved when the seat is pushed backwards. Such a wall is e.g. arranged behind the seat 1 in a sports car. However, the object 12, 12′ can also be a box, a bag or another object which is arranged in particular behind, underneath or in front of the seat 1.

As a result of the movement of the seat 1 against or onto the object 12, 12′, the seat 1 is lifted up by the object 12, 12′, i.e. the load is decreased on those mountings and hence also those weight sensors which are assigned to the region that is facing towards the object 12, 12′. Furthermore, the load is increased on those mountings and weight sensors which are assigned to the region of the seat 1 that is facing away from the object 12, 12′. If the seat 1 is moved against the wall, for example, the load is reduced on the mountings and weight sensors which are assigned to the rear region of the seat 1 and the load is increased on the mountings and weight sensors which are assigned to the front region of the seat 1. Correspondingly, if the seat 1 is moved against the object 12′ that is arranged in front of the seat 1, the load is reduced on the mountings and weight sensors which are assigned to the front region of the seat 1 and the load is increased on the mountings and weight sensors which are assigned to the rear region of the seat 1.

A current center of force P is preferably calculated from the measured values of the four weight sensors. Due to the jamming of the seat 1 as a result of the movement of the seat 1 against the wall, i.e. against the object 12, the current center of force P is shifted forwards to a position 13 of the current center of force P. Correspondingly, due to the jamming of the seat 1 as a result of the movement of the seat 1 against the object 12′, the current center of force P is shifted rearwards to a position 13′ of the current center of force P. As a result of this, the position 13, 13′ of the current center of force P lies outside of a predetermined central region 14. The predetermined central region 14 represents a reliable value range for the position 13, 13′ of the current center of force P. This reliable value range is selected such that departure from said range never or only rarely occurs during use of the seat 1 in an unjammed state A, but departure from said range occurs routinely as a result of the seat 1 jamming. Furthermore, this predetermined value range is dependent on an embodiment of the seat 1 and the arrangement of the mounting and weight sensors.

FIG. 3 shows a diagram in which a load L is plotted over a time t. This load L is e.g. a mass which is assigned to the measured values that have been captured. However, the load L can likewise represent the force acting on the relevant weight sensor.

The diagram illustrates measured values MW1 of the first weight sensor 7, measured values MW2 of the second weight sensor 8, measured values MW3 of the third weight sensor 9, and measured values MW4 of the fourth weight sensor 10 in their time-relative profile. A mean load mL is also illustrated in its time-relative profile. The mean load mL is e.g. a low-pass filtered mean value of the measured values MW1, MW2, MW3, MW4 of the first, second, third and fourth weight sensors 7, 8, 9, 10.

The diagram shows a transition of the seat 1 from the unjammed state A into a jammed state B, e.g. as a result of moving the seat 1 against the object 12 which is arranged behind the seat 1. The measured values of the weight sensors show a characteristic profile in this case. The measured values MW1, MW2 of the first and second weight sensors 7, 8, i.e. the measured values of those weight sensors which are assigned to the front region of the seat 1, increase and the measured values MW3, MW4 of the third and fourth weight sensors 9, 10, i.e. the measured values of the weight sensors which are assigned to the rear region of the seat 1, decrease in the time-relative profile during the jamming.

In addition to this, the mean load mL also decreases, i.e. a weight force which acts on the seat 1 and is caused e.g. by a person sitting on the seat 1 is incorrectly reduced as a result of the jamming of the seat 1. However, this can result in an incorrect classification of the person sitting on the seat 1. In the case of weight-based occupant recognition in a motor vehicle, recognizing that the seat 1 has jammed is therefore important for the safety of the occupant concerned.

The measured values of each weight sensor are preferably captured by the analysis device 11 at predetermined time intervals and at separate times from each other in each case. In each case, however, at least two measured values of the respective weight sensors are captured within a predetermined time period T. This is necessary in order to be able to recognize changes, i.e. an increase or a decrease in the measured values of the respective weight sensor. However, it is also possible to capture more than two measured values of the respective weight sensors within the predetermined time period T. In particular, it is also possible in each case to capture a continuous profile of the measured values of the respective weight sensors. The predetermined time period T is preferably several seconds, e.g. ten seconds. However, the predetermined time period T can also be shorter or longer.

FIGS. 4A and 4B show a flow diagram of a program for recognizing the jamming of the seat 1. The program is preferably executed in the analysis device 11. The program starts in a step S1. In a step S2, a measured value is captured for each weight sensor at a first time point t1. Separated by time, e.g. several milliseconds or seconds later but within the predetermined time period T, a measured value is captured in each case for each weight sensor at a second time point t2 in a step S3. Within the predetermined time period T, in a step S4 or further steps at further time points tn, a measured value can be captured in each case for each weight sensor.

In a step S5, depending on the captured measured values of the respective weight sensors, an increase of the measured values is calculated for each weight sensor. For example, an increase A1 of the measured values MW1 of the first weight sensor 7, an increase A2 of the measured values MW2 of the second weight sensor 8, an increase A3 of the measured values MW3 of the third weight sensor 9, and an increase A4 of the measured values MW4 of the fourth weight sensor 10 are calculated.

In a step S6, a check establishes whether the characteristic profile of the measured values of the relevant weight sensors which occurs for the transition from the unjammed state A of the seat 1 to the jammed state B of the seat 1 is present. In addition, a check establishes whether the increases A1, A2 of the measured values MW1, MW2 of the first and second weight sensors 7, 8 which are assigned to the front region of the seat 1 are greater than zero and the increases A3, A4 of the measured values MW3, MW4 of the third and fourth weight sensors 9, 10 which are assigned to the rear region of the seat 1 are less than zero, or whether the increases A1, A2 of the measured values MW1, MW2 of the first and second weight sensors 7, 8 are less than zero and the increases A3, A4 of the measured values MW3, MW4 of the third and fourth weight sensors 9, 10 are greater than zero.

If this condition is not satisfied, i.e. if the characteristic profile of the measured values of the relevant weight sensors is not present, then the program is continued in a step S7. In the step S7, the unjammed state A of the seat 1 is recognized and the program terminates in a step S8. If the condition in the step S6 is satisfied, however, i.e. if the characteristic profile of the measured values of the relevant weight sensors is present, then the current center of force P is preferably calculated in a step S9 depending on the measured values of the weight sensors. In a step S10, a check then establishes whether the calculated current center of force P lies outside of the predetermined central region 14.

Alternatively or additionally, in the step S9 it is also possible to calculate an amount of a difference DIFF between measured values of the weight sensors which are assigned to the front region of the seat 1 and the measured values of the weight sensors which are assigned to the rear region of the seat 1. A check in the step S10 then checks whether the amount of the difference DIFF exceeds a predetermined differential threshold value D_THR.

If the condition in the step S10 is satisfied, the jammed state B of the seat 1 is recognized in a step S11 and the program is terminated in the step S8. If the condition in the step S10 is not satisfied, however, the unjammed state A of the seat 1 is recognized in the step S7 and the program is terminated in the step S8.

Alternatively or additionally to the steps S9 and S10, in a step S12 it is possible to check whether the increases A1, A2, A3, A4 of the measured values MW1, MW2, MW3, MW4 of the first, second, third and fourth weight sensors 7, 8, 9, 10 exceed a predetermined increase threshold value A_THR in terms of their amount in each case.

The program is executed again in the step S1 after a delay period TW, for example.

Instances of the seat 1 jamming are preferably recognized if the jamming takes place in such a way that the current center of force P is shifted forwards or backwards. However, it is also possible to recognize instances of the seat 1 jamming in which the current center of force P is shifted sideways, i.e. to the right or the left, or diagonally. The checks in the steps S6, S10 and/or S12 must be changed or supplemented correspondingly for this purpose.

1-5. (canceled)

6. A method for recognizing a jamming of a seat, which comprises the steps of:
capturing at least two measured values which are separated by a time interval in each case within a predetermined time period by at least two weight sensors disposed below the seat such that measured values from the at least two weight sensors are representative of a force transferred from the seat to a seat mounting, and at least one of the weight sensors is disposed in a first region of the seat and at least one of the weight sensors is disposed in a second region of the seat;
calculating an increase from the at least two measured values in each case for a relevant weight sensor; and
recognizing a jamming of the seat in dependence on a presence of different operational signs of increases attributed to the at least one weight sensor disposed in the first region of the seat and to the at least one weight sensor disposed in the second region of the seat.

7. The method according to claim 6, which further comprises recognizing the jamming of the seat if the increases, which are attributed to the at least one weight sensor disposed in the first region of the seat and the at least one weight sensor disposed in the second region of the seat, exceed a predetermined increase threshold value in terms of their amount in each case.

8. The method according to claim 6, which further comprises recognizing the jamming of the seat if, within the predetermined time period and in dependence on the presence of the different operational signs of the increases, an amount of a difference between the measured values of the at least one weight sensor disposed in the first region of the seat and the at least one weight sensor disposed in the second region of the seat exceeds a predetermined difference threshold value.

9. The method according to claim 6, which further comprises:
calculating a current center of force from the measured values of the weight sensors; and
recognizing the jamming of the seat if, within the predetermined time period and in dependence on the presence of the different operational signs of the increases, a position of the current center of force lies outside of a predetermined central region.

10. A device for recognizing a jamming of a seat, the device comprising:
an analysis device programmed to:
capture at least two measured values in each case, the measured values being separated by a time interval, within a predetermined time period from at least two weight sensors disposed below the seat such that the measured values of the at least two weight sensors are representative of a force transferred from the seat to a seat mounting, at least one weight sensor is disposed in a first region of the seat and at least one weight sensor is disposed in a second region of the seat;
calculate an increase from the at least two measured values in each case for a relevant weight sensor; and
recognize the jamming of the seat in dependence on a presence of different operational signs of increases attributed to the at least one weight sensor disposed in the first region of the seat and to the at least one weight sensor disposed in the second region of the seat.
